(19) United States
(12) Patent Application Publication
(10) Pub. No.: US 2026/0048950 A1
(43) Pub. Date: Feb. 19, 2026

(54) TRANSFER DEVICE AND METHOD FOR TRANSFERRING PACKAGING UNITS

(71) Applicant: Uhlmann Pac-Systeme GmbH & Co. KG, Laupheim (DE)

(72) Inventors: Bernd HAEHNEL, Laupheim (DE); Wolfgang RODI, Laupheim (DE); Martin DANGELMAYR, Laupheim (DE); David KLEINE-HEGERMANN, Laupheim (DE)

(21) Appl. No.: 19/301,374

(22) Filed: Aug. 15, 2025

(30) Foreign Application Priority Data
Aug. 16, 2024 (EP) 24194859.5

(51) Int. Cl. B65G 47/91; B65G 57/04

(52) U.S. Cl. CPC B65G 47/914; B65G 57/04; B65G 2201/022

(57) ABSTRACT

A transfer device for transferring packaging units has at least one eccentric unit with a rotatably mounted eccentric element, which has a rod lead-through for a rod. The rod is mounted, by means of the rod lead-through, in a rotatable manner and in a displaceable manner in the axial direction of the eccentric element. The transfer device also has a first drive unit for rotating the eccentric element and a second drive unit for displacing the rod. A holding device for receiving packaging units is connected to the rod.

### CROSS-REFERENCE TO RELATED APPLICATIONS

This application claims the benefit of and priority under 35 U.S.C. § 119 to European Patent Application No. 24 194 859.5 filed Aug. 16, 2024, the contents of which is incorporated herein by reference in its entirety.

### FIELD

The present disclosure relates to a transfer device for transferring packaging units and a method for transferring packaging units.

### BACKGROUND

As a result of increasing quantities and growing productivity requirements, devices for producing, further processing, packaging and order picking of products are required, which are characterized by a high performance. This means in particular that a high reliability as well as a very short clock time or product processing time, respectively, is demanded on the part of the operators. When order picking and packaging units, it is often required to stack packaging units, which requires a handling or transfer, respectively, of a clocked or continuous conveying device to a delivery region. In addition, there is a trend towards a wide range of and individual packaging, all of which are to be handled with a transfer. For example, known universal portals or robots can be used for the transfer. They have high acquisition costs, however, are comparatively slow and can thus not reach the required clock times. Such known portals or robots are furthermore technically extremely complex, which generally makes the repair and maintenance thereof as well as a wide range of application more difficult.

### SUMMARY

The present disclosure at least partly overcomes the above-mentioned disadvantages and provides an improved device for transferring packaging units, which has a short clock time, can handle a variety of different packaging units and which can be produced and maintained easily.

According to an aspect of the present disclosure, a transfer device for transferring packaging units from a receiving region to a delivery region is proposed, wherein the transfer device comprises at least one eccentric unit. The eccentric unit comprises a rotatably mounted eccentric element, which has a rod lead-through, which is spaced apart from an axis of rotation of the eccentric element in the radial direction and which extends parallel to the axis of rotation of the eccentric element. The eccentric unit additionally has a rod, which extends through the eccentric element and which is mounted, by means of the rod lead-through, in a rotatable manner and in a displaceable manner in the axial direction of the eccentric element. The eccentric unit additionally has a holding device, which is directly or indirectly connected to the rod, preferably in the region of a first end of the rod, and which is configured to receive at least one packaging unit. A first drive unit is configured to rotate the eccentric element, whereby the holding device is moved in a first plane, which is perpendicular to the axis of rotation of the eccentric element, between a retracted position and an operating position. A second drive unit is configured to displace the rod between a first translation position and a second translation position in the axial direction of the eccentric element, whereby the holding device is moved parallel to the axis of rotation of the eccentric element.

A transfer device for transferring packaging units, which has a simple mechanical structure and which provides for a short clock time, is proposed with particular advantage hereby. The transfer device has only two moved elements, which provide for a high travel speed and a high positioning accuracy. The simple mechanical structure is particularly robust, maintenance-friendly and reliable, which is particularly advantageous for the operator of the transfer device.

Packaging units can be, for example, blister packaging, tray packaging, bag packaging, wallets, folding boxes or cardboard boxes.

It is preferably provided that a rotational position of the holding device remains unchanged during the rotation of the eccentric element. It is ensured hereby that the orientation of a packaging unit received by the holding device remains unchanged in spite of the rotation of the eccentric element, which promotes a quick translation of packaging units.

The second drive unit advantageously transmits a feed force to the second end of the rod for the displacement of the rod.

The rod is preferably fixed to a bearing element with respect to a rotation around its axis, particularly preferably with its second end, and the bearing element follows the rotational movement of the rod around the axis of rotation, which results from the rotation of the eccentric element. The rotational position of the holding device can easily be held in an unchanged manner in the case of a rotating rod by means of this design. The mounting is preferably formed by means of a joint rod or linear guides. Particularly preferably, two linear guides are provided. The first and the second linear guide are preferably arranged perpendicular to one another.

The rod is preferably a hollow rod, at least in sections. The through-channel through the rod formed in this way preferably extends over the entire length of the rod. The through-channel can be open exclusively towards the first end and towards the second end of the rod. In addition, the through-channel can at least partly be formed to be open towards an outer circumferential side of the rod. The through-channel can be designed, for example, as a groove, which extends from the first end to the second end of the rod. The through-channel makes it possible to guide lines through the rod to the holding device. The through-channel preferably has a diameter between 10 and 50 mm, particularly preferably between 20 and 30 mm. Alternatively, the through-channel itself can be used as a line, in order to provide, for example, compressed air for the holding device.

The first drive unit and the second drive unit can preferably be capable of being controlled independently of one another. This provides for a superposition of the rotatory movement of the holding device with the translatory movement of the holding device between the first and second translation position, whereby the clock time of the transfer device can thus be lowered. This increases the productivity of the transfer device with particular advantage.

It is preferred that the eccentric unit is configured to simultaneously carry out a movement of the holding device parallel to the axis of rotation of the eccentric element and parallel to the first plane at least in sections. Due to these two simultaneous movements, the clock time of the transfer device can be reduced in an advantageous manner. Due to the simultaneous movements at least in sections, it is furthermore possible to position the holding device at each point of the operating region of the transfer device. The complete operating region is preferably formed cylindrically. More precisely, the operating region is determined by the distance of the rod lead-through or of the rod, respectively, to the axis of rotation and the distance between the first and second translation position.

An advantageous further aspect provides that the eccentric unit is configured to synchronize the above-mentioned movements of the holding device with a movement of a conveying device of the transfer device in the receiving region. Alternatively or additionally, it is preferred that the eccentric unit is configured to synchronize the above-mentioned movements of the holding device with a movement of a conveying device for packaging units in the delivery region. The transfer device can be operated particularly efficiently hereby.

A further aspect provides that the transfer device comprises a plurality of eccentric units, which are arranged next to one another in such a way that the axes of rotation of the plurality of eccentric elements are arranged parallel to one another. The multiplication of eccentric units increases the productivity of the transfer device, whereby more packaging units can be transferred in a given clock time. This measure furthermore promotes a compact structure of the transfer device. A plurality of packaging units are thereby preferably likewise at least partly arranged one behind the other in their receiving regions and/or delivery regions.

It is also advantageous that the rods of the plurality of eccentric units are coupled to one another. This can take place, for example, via a coupling rod or coupling plate between the rods. In a preferred design, the holding device can preferably also be arranged on the coupling rod or coupling plate. In the case of two rods, more than two holding device can also be arranged on the coupling rod or coupling plate. In its main direction of extension, the coupling rod or coupling plate preferably extends perpendicular to the axial direction of the plurality of rods.

The plurality of eccentric units can then in each case be driven by means of separate first drive units, but only one motor is preferably present, which synchronously drives at least two and up to all eccentric units.

In the case of multiple eccentric units, the second drive unit is preferably configured to jointly displace the rods of at least two and up to all eccentric units in the axial direction of the eccentric elements between the first translation position and the second translation position. It is possible hereby to use only a second drive unit for a plurality of eccentric units. An even clock rate for delivering the packaging units in the delivery region can furthermore be attained by means of a joint movement of the holding device of the plurality of eccentric units.

It is preferred when at least some eccentric units of the plurality of eccentric units can be adjusted in such a way that a distance between the axes of rotation of certain eccentric elements can be set relative to one another. The transfer device can thus be adapted easily to different formats of packaging units and/or different distances between the packaging units.

Alternatively or additionally, an adaptation to different formats of packaging units and/or different distances between the packaging units can also take place by means of an adjustment of the holding device and/or of the suction grippers relative to the rod or the rods.

A preferred further aspect provides that the holding device is configured to receive a plurality of packaging units. The productivity of the transfer device can be further increased hereby and the clock time thereof can be lowered. An expedient further development provides that the holding device is configured to individually or separately receive and/or deliver, respectively, individual packaging units of the plurality of packaging units. The holding device can thus react to empty spaces in the receiving region, whereby an efficient transfer without waiting times is promoted.

It is preferred that the holding device has at least one suction gripper. Suction grippers can be used universally and can securely support products with flat surfaces. In addition, the reaction time for receiving and delivering a packaging unit is extremely short when using a suction gripper. Alternatively, any other type of grippers can be provided, for example a clamping grippers or Bernoulli grippers.

A distance between the first translation position and the second translation position is preferably 30 to 800 mm, more preferably 40 to 700 mm and particularly preferably 50 to 600 mm. The distance is measured in a direction, which is parallel to the axis of rotation of the eccentric element. When the distance lies within the specified ranges, a plurality of different packaging unit formats can be transferred in different arrangements by means of the transfer device and the travels of the rod between the first and second translation position can nonetheless be kept short.

A length of the chord between the retracted position and the operating position is preferably 10 to 200 mm, more preferably 20 to 150 mm and particularly preferably 30 to 100 mm. When the length falls within the specified ranges, the eccentric element is compact and can be accelerated and decelerated quickly, whereby the clock time is positively influenced.

The eccentric element is preferably mounted in a rotatory manner in the eccentric unit. The eccentric element is preferably cylindrical, particularly preferably a shaft or a circular plate. The eccentric element can additionally be made in multiple parts.

The eccentric element can generally have one or more bearing sections. The eccentric element particularly preferably has two bearing sections, which are each arranged on end regions of the eccentric element along the axis of rotation thereof. The at least one bearing section is furthermore preferably concentric to the axis of rotation of the eccentric element. The bearing sections are preferably each mounted by means of a radial bearing, for example a ball bearing, which is supported by a housing of the eccentric unit.

It is further likewise conceivable that the eccentric element is formed in multiple parts. The two bearing sections and the middle section can in particular be formed as individual components, which are joined. Due to the multi-part formation of the eccentric element, the manufacture thereof can be simplified significantly and the price can be reduced significantly.

In preferred design, the eccentric element can generally comprise two shafts, disks or plates lying opposite one another, between which a connecting middle section lies, which is not concentric to the axis of rotation of the eccentric element. The middle section can preferably be formed cylindrically.

The eccentric element can furthermore have counter weights for compensating moments of inertia of the first and/or second order. It is possible by means of the mentioned measures to provide an eccentric element, which shows few to no vibrations during the operation, whereby, for example, high travel speeds of the transfer device can be realized.

The housing of the eccentric unit can be formed in one part or multiple parts. The housing is particularly preferably formed in multiple parts. The multi-part housing can have two mounting plates, which are spaced apart from one another by means of spacer sleeves. Each of the mounting plates preferably supports a radial bearing for mounting the eccentric element. It is furthermore preferred that the eccentric element extends between and through the two mounting plates. At least the bearing sections of the eccentric element preferably each extend through the mounting plates, while the middle section of the eccentric element extends between the mounting plates. It can further be provided that the two mounting plates differ, whereby only one mounting plate is formed to receive the first drive unit. A particularly simple and light housing is proposed hereby.

It is further preferred that the rod lead-through completely passes through the eccentric element parallel to the axis of rotation thereof. The rod lead-through preferably has a radial-axial bearing, which is configured to mount the rod both axially as well as in a rotatory manner with respect to the eccentric element.

The rod preferably has a cylindrical cross section. The cross section of the rod, however, is not limited to a specific cross section. Provided that the rod has a non-cylindrical cross section, a bearing element can be provided, which mounts the rod in the axial direction and the radial bearing, in turn, mounts the bearing element together with the rod in a rotatory manner.

The holding device rotates around the axis of rotation of the eccentric element in a first plane. The first plane is preferably not stationary and can be moved by means of the displacement of the rod together with the holding device. The holding device preferably rotates around the axis of rotation of the eccentric element at a distance specified by the rod lead-through.

The first drive unit can drive the eccentric element directly or indirectly in a rotatory manner. The first drive unit is preferably formed by a controllable stepper motor or a servo motor with rotary encoder. A rotatory position, a speed and an angular acceleration of the eccentric element and thus of the holding device can be controlled or regulated hereby, respectively. The first drive unit preferably transmits a rotatory drive force to the eccentric element via a gear unit. The gear unit preferably has a chain or a toothed belt, which transmit a torque of the first drive to the eccentric element. The gear unit preferably provides a positive force transmission. The use of a gear unit, in particular of a gear unit with a gear reduction, generally increases the torque acting on the eccentric unit and the rotatory positioning accuracy of the eccentric element.

The second drive unit is likewise formed by means of a stepper motor or a servo motor with rotary encoder, whereby the displacement of the rod and thus the movement of the holding device parallel to the axis of rotation of the eccentric element can be controlled or regulated, respectively.

The receiving region and the delivery region can generally be spaced apart from one another in three dimensions. The receiving and delivery region are expediently dimensioned so that at least one packaging unit can in each case be arranged in them. The receiving and delivery region are preferably stationary. Alternatively, at least one of receiving and delivery region can be moved.

The receiving region and the delivery region can also lie on a common line in one dimension or in two dimensions.

A continuously running conveying device, which transports the packaging units, can preferably be arranged in the receiving region. A conveying device, which is moved in a clocked manner, is also conceivable. Instead of the conveying device, other conveying or support means, which are moved continuously or in a clocked manner, or stationary conveying or support means can generally also be provided. Each of these elements on its own defines the receiving region at a predefined location.

A stacking shaft or other stationary conveying or support means, which are moved continuously or in a stationary manner, can be provided in the delivery region. Each of these elements on its own defines the delivery region at a predefined location.

The rotational movement of the rod and thus of the holding device can take place continuously or in a clocked manner. In addition, it can take place in only one direction or in opposite directions in sections. A variety of movement patterns of the holding device can be set in this way.

The retracted position and the operating position of the holding device are accordingly also not predefined. They can be at different locations of their circular movement.

In the embodiments described in more detail in the figures, the operating position lies, for example, at a lower vertex of the circular movement. However, it can also lie at a different location of the circle, in particular in the case of a back and forth rotational movement.

The retracted position is likewise not predefined. In the embodiments described in more detail in the figures, it lies, for example, at an upper vertex of the circular movement. However, it can also lie at a different location of the circle, in particular in the case of a back and forth rotational movement.

The operating position has to additionally not mandatorily be equal in the receiving region and in the delivery region. It is also conceivable that the packaging units are received at a height level, which differs from the height level at which they are delivered.

According to another aspect of the present disclosure, a method for transferring packaging units from a receiving region to a delivery region by means of the above-described transfer device comprises the following steps:
rotating the eccentric element by means of the first drive unit in order to move the holding device into an operating position;
receiving the at least one packaging unit in the receiving region by means of the holding device;
rotating the eccentric element by means of the first drive unit in order to move the holding device into a retracted position;
displacing the rod from the first translation position into the second translation position by means of the second drive unit;
rotating the eccentric element by means of the first drive unit in order to move the holding device into an operating position;
delivering the at least one packaging unit in the delivery region by means of the holding device;
rotating the eccentric element by means of the first drive unit in order to move the holding device into a retracted position; and
displacing the rod from the second translation position into a first translation position by means of the second drive unit.

A packaging unit can be transferred in a simple way and in an extremely low clock time with the help of this proposed method.

It is not necessary that each step of the method has to be concluded before the next step begins. On the contrary, in particular the steps of receiving and delivering will preferably take place during the rotational movement.

It is also preferred that the translatory displacement of the rod partly takes place so as to overlap with the rotational movement, in order to save time.

The packaging units can be continuously moved on a conveying device and the movements of the at least one eccentric unit can be synchronized with the movements of the packaging units on the conveying device.

It is clarified that all features, which have been described with regard to the transfer device, can likewise be transferred to the method and vice versa.

### BRIEF DESCRIPTION OF THE DRAWINGS

FIG. 1 is a schematic perspective view of a transfer device according to a first embodiment of the present disclosure during the movement of the eccentric element in the direction of the operating position in the receiving region, wherein the holding device is in the first translation position;

FIG. 2 is a schematic perspective view of the transfer device from FIG. 1 with the eccentric element in the operating position;

FIG. 3 is a schematic perspective view of the transfer device from FIG. 1 during the movement of the holding device from the first translation position in the direction of the second translation position between the receiving region and the delivery region;

FIG. 4 is a schematic perspective view of the transfer device from FIG. 1 with the eccentric element in the operating position and the holding device in the first translation position, wherein different distances are present between the individual packaging units lying on the conveying device;

FIG. 5 is a schematic perspective view of a transfer device according to a second embodiment of the present disclosure during the movement of the eccentric element in the direction of the operating position in the receiving region, wherein the holding device is in the first translation position;

FIG. 6 is a schematic perspective view of the transfer device from FIG. 5 with the eccentric element in the operating position and the holding device in the second translation position in the delivery region;

FIG. 7 is a schematic perspective view of a transfer device according to a third embodiment of the present disclosure during the movement of the eccentric elements in the direction of the operating position in the receiving regions, wherein the holding devices are in the first translation position.

### DETAILED DESCRIPTION

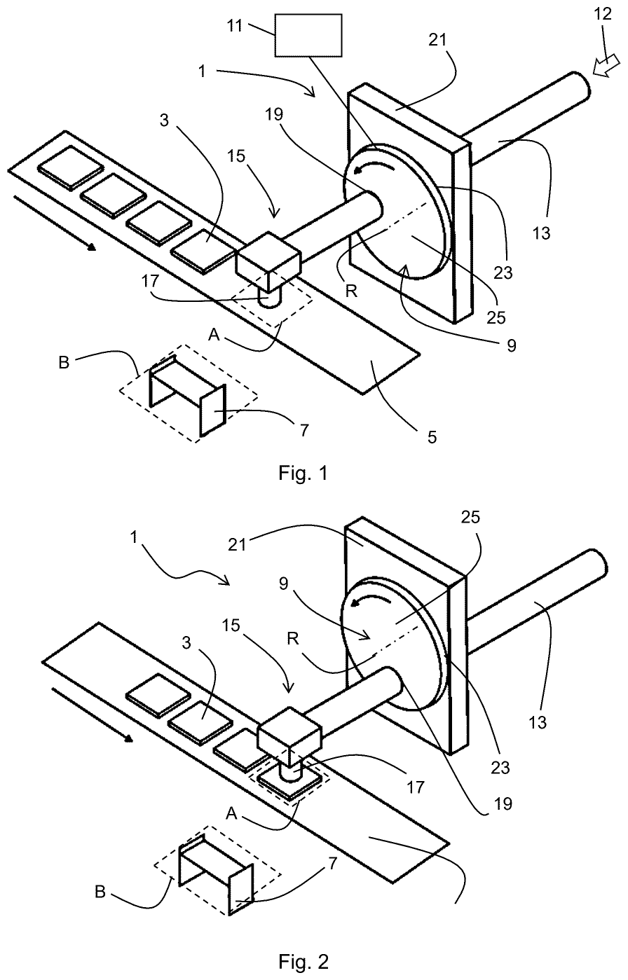

A transfer device according to a first embodiment of the present disclosure is illustrated in FIG. 1. The transfer device is used within a packaging machine, in order to relocate packaging units 3, which are already filled and sealed, from a conveying device 5 into a stacking shaft 7. The stacking shaft 7 serves the purpose of stacking the packaging units 3 and to order pick them in an order-related manner. The conveying device 5 conveys the packaging units 3 into the receiving region A at a continuous speed.

The stacking shaft 7 is empty in FIG. 1. The packaging units 3 are always delivered at the same location in the stacking shaft 7. After the delivery of a packaging unit 3, the stacking shaft 7 is preferably lowered. A filled, lowered stacking shaft 7 is illustrated in FIG. 3.

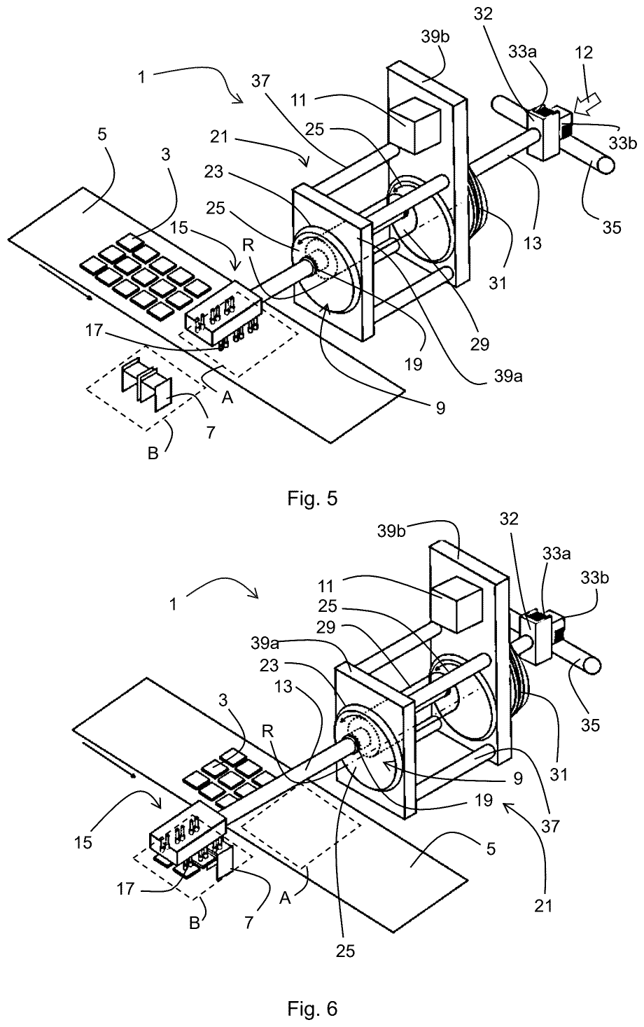

The transfer device comprises an eccentric unit 2, which comprises an eccentric element 9, which is driven in a rotatory manner by a first drive unit 11. The drive unit 11 is described in more detail below with reference to FIG. 5.

The eccentric element 9 has a rod 13, which is rotatably and displaceably mounted by the eccentric element 9. A holding device 15, which is configured for receiving and delivering a packaging unit 3, is provided on one end of the rod 13. In this preferred embodiment, the holding device 15 has a suction gripper 17.

The eccentric element 9 rotates around an axis of rotation R, wherein the rod 13 extends parallel to the axis of rotation R and is mounted eccentrically to the axis of rotation R. The rod 13 extends through the eccentric element 9 by means of a rod lead-through 19. The rod lead-through 19 further has a radial-axial bearing, which is formed in such a way that the rod 13 is mounted displaceably in an axial direction parallel to the axis of rotation R, as well as rotatably. The orientation of the holding device 15 is thus independent of the rotatory position of the eccentric element 9. The eccentric element 9 itself is mounted in a rotatory manner in a housing 21 of the eccentric unit 2 by means of a circumferential radial bearing 23. In the embodiment illustrated in FIG. 1, the eccentric element 9 is formed as a plate-shaped disk, which simultaneously serves as bearing section 25. The bearing section 25 is received on the outer circumferential side by the radial bearing 23, which, in turn, is supported by the housing 21 of the eccentric unit 2.

In addition to the mounting in the eccentric element 19, the rod 13 is also mounted at a different location in such a way that it can be displaced in a translatory manner parallel to the axis of rotation R by a second drive 12. A possible design of the bearing element 32 for the rod is described further below with reference to FIG. 5.

In FIG. 1, the eccentric element 9 is moved in the direction of the operating position, in which the holding device 15 can receive the packaging unit 3 from the conveying device 5. In FIG. 1, the holding device 15 is located in the first translation position and is positioned above the receiving region A here.

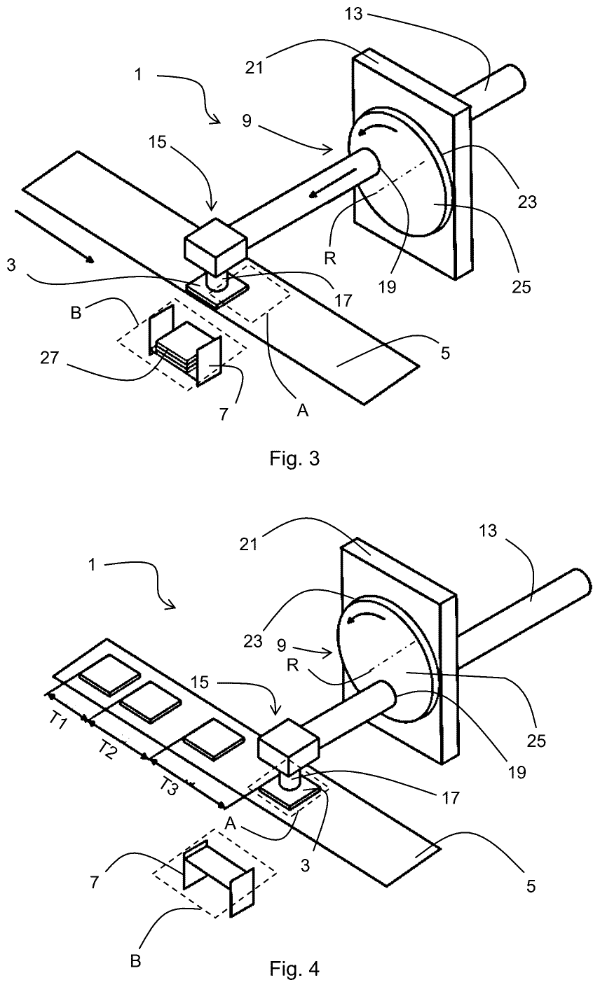

FIG. 2 shows the transfer device of FIG. 1, in which the eccentric element 9 is in the operating position and the holding device 15 is in the first translation position. In the operating position, the suction gripper 17 is in contact with the packaging unit 3, so that the latter can be gripped securely by the suction gripper 17. It can be seen in the combined view with FIG. 1 that the movement of the conveying device 5 is synchronized with the movement of the eccentric unit 2. In other words, the position of at least one packaging unit 3 in the receiving region A is synchronized with the movements of the holding device 15 around the axis of rotation R and axially, parallel to the axis of rotation R. The eccentric element 9 is thus controlled or regulated, respectively, in such a way by the first drive unit 11 that the eccentric element 9 is in the operating position when a packaging unit 3 is in the receiving region A.

It can be seen in FIG. 3 that the holding device 15 is moved in the direction of the second translation position. A stack 27 of transferred packaging units 3 has already been formed in the stacking shaft 7. The stacking shaft 7 is further lowered compared to the state, which is illustrated in FIGS. 1 and 2. For example, no further packaging unit 3 is illustrated in the illustrated section of the conveying device 5 in this design, in order to show a further field of application of the transfer device compared to FIGS. 1 and 2. This could be the case, for example, in response to a clocked movement or a very quick movement of the conveying device 5.

FIG. 4 shows the eccentric unit 2 from FIG. 1 with the eccentric element 9 in the operating position and the holding device 15 in the first translation position, wherein different distances T1, T2 and T3 between the individual packaging units 3 on the conveying device 5 are illustrated. Due to the synchronization, even empty spaces on the conveying device 5 can be compensated by means of the transfer device, whereby said transfer device can be used in an extremely flexible manner.

FIG. 5 shows a transfer device according to a second embodiment of the present disclosure during the movement of the eccentric element 9 in the direction of the operating position in the receiving region A, wherein the holding device 15 is in the first translation position. The second embodiment represents a modification of the first embodiment, which is why only the differences between these two embodiments will be discussed below with regard to FIG. 5.

The housing 21 of the second embodiment is formed in multiple parts. It comprises two mounting plates 39a, 39b, which each receive a radial bearing 23, which mounts the eccentric element 9 in a rotatory manner. The mounting plates 39a, 39b are spaced apart from a plurality of spacer sleeves 37, whereby a simple housing 21 is formed.

It can furthermore be seen that the first drive unit 11 drives the eccentric element 9 by means of a belt drive 31. The belt of the belt drive 31 thereby winds around a section of the eccentric element 9. The belt drive 31 is of a positive type, such as, for example, a toothed belt drive, so that an exact positioning of the eccentric element 9 is attained via the first drive unit 11.

The eccentric element 9 is formed in multiple parts here, wherein two bearing sections 25 are arranged on opposite sides of the eccentric element 9 along the axis of rotation R thereof. The bearing sections 25 are spaced apart from one another by means of a middle section 29. The middle section 29 has a cross section, which is changed compared to the bearing sections 25. The middle section 29 is further illustrated cylindrically here, wherein the cylinder axis thereof is arranged parallel to the axis of rotation R.

The rod lead-through 19 extends through the two bearing sections 25 and the center section 29. In this embodiment, the radial-axial bearing of the rod lead-through 19 (not illustrated here) can at least partly also be arranged in the middle section 29 in this embodiment. The eccentric unit 2 furthermore has a holding device 15 with a plurality of suction grippers 17, which can accordingly receive and deliver a plurality of packaging units 3.

Two linear guides 33a, 33b for mounting the second end of the rod 13 are furthermore provided in FIG. 5 as bearing element 32. The two linear guides 33a, 33b are arranged perpendicular to one another. The linear guide 33b is connected to a coupling rod 35, which is moved by the second drive 12 in a direction along the axis of rotation R, in order to displace the holding device 15 between the first and second translation position. The linear guides 33a, 33b mount the rod 13 in two directions, which are each perpendicular to one another and perpendicular to the axis of rotation R. It can furthermore be seen in FIG. 5 that the coupling rod 35 is arranged perpendicular to the rod 13.

In the second embodiment, the receiving region A is accordingly dimensioned in such a way that a certain number of packaging units 3, which can be simultaneously received by the holding device 15, can be arranged in said receiving region. Two stacking shafts 7 arranged next to one another are located in the delivery region B here.

The transfer device from FIG. 5 with the eccentric element 9 in the operating position and the holding device 15 in the second translation position in the delivery region B can be seen in FIG. 6. In the combined view with FIG. 5, the movement of the holding device 15 between the first and the second translation position can be seen. Six packaging units 3 are received on the holding device 15 by means of the suction grippers 17. In the second embodiment, the holding device 15 is preferably formed to selectively receive and deliver the packaging units 3. It can be seen in FIG. 6 that the holding device 15 in each case selectively places down two packaging units 3 in the two stacking shafts 7, which are arranged next to one another in the delivery region B. It can also be seen in FIG. 6 that the coupling rod 35 together with the linear guides 33a, b is displaced in the axial direction of the rod 13.

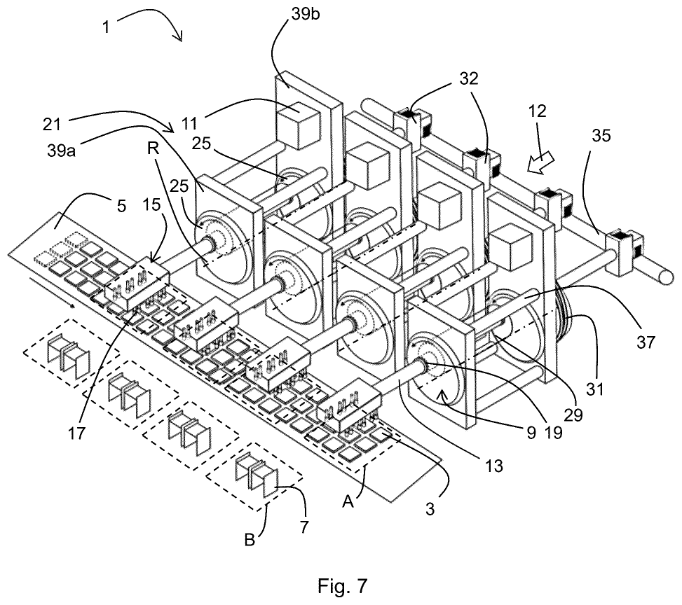

FIG. 7 illustrates a third embodiment of the transfer device with a plurality of eccentric units 2 as described in the second embodiment according to FIGS. 5 and 6.

The image shows the state during the movement of the eccentric elements 9 in the direction of the operating position in the receiving regions A, while the holding devices 15 are in the first translation position. FIG. 7 represents a further development of the second embodiment by multiplication of the components of the transfer device.

The rods 13 of the plurality of eccentric units 2 are arranged parallel to one another and are jointly connected to the coupling rod 35. The second linear bearings 33b are connected to the coupling rod 35 and the first linear bearings 33a are connected to the respective rods 13. Each eccentric unit 2 has a separate receiving region A and a separate delivery region B.

1. A transfer device for transferring packaging units from a receiving region to a delivery region,
wherein the transfer device comprises at least one eccentric unit which comprises:
a rotatably mounted eccentric element having a rod lead-through, the rod-lead through being spaced apart from an axis of rotation of the eccentric element in a radial direction and extending parallel to an axis of rotation of the eccentric element;
a rod, which extends through the eccentric element and which is mounted, by way of the rod lead-through, in a rotatable manner and in a displaceable manner in an axial direction of the eccentric element, wherein the rod lead-through has a radial-axial bearing, which is configured to mount the rod both axially as well as in a rotatory manner with respect to the eccentric element;
a holding device, which is connected to the rod and which is configured to receive at least one packaging unit;
a first drive unit, which is configured to rotate the eccentric element, thereby moving the holding device in a first plane, which is perpendicular to the axis of rotation of the eccentric element, between at least one retracted position and at least one operating position; and
a second drive unit, which is configured to displace the rod between at least one first translation position and at least one second translation position in the axial direction of the eccentric element, thereby moving the holding device parallel to the axis of rotation of the eccentric element.

2. The transfer device according to claim 1, wherein a rotational position of the holding device remains unchanged during rotation of the eccentric element.

3. The transfer device according to claim 1, wherein the rod is fixed to a bearing element with respect to a rotation around its axis and the bearing element follows a rotational movement of the rod around the axis of rotation, which results from the rotation of the eccentric element.

4. The transfer device according to claim 1, wherein the rod is a hollow rod at least in sections.

5. The transfer device according to claim 1, wherein the first drive unit and the second drive unit can be controlled independently of one another.

6. The transfer device according to claim 5, wherein the eccentric unit is configured to simultaneously carry out a movement of the holding device parallel to the axis of rotation of the eccentric element and parallel to the first plane at least in sections.

7. The transfer device according to claim 1, comprising a plurality of eccentric units, which are arranged next to one another in such a way that the axes of rotation of the plurality of eccentric elements are arranged parallel to one another.

8. The transfer device according to claim 7, wherein the rods of at least two and up to all eccentric units are coupled to one another.

9. The transfer device according to claim 7, wherein the second drive unit is configured to jointly displace the rods of at least two and up to all eccentric units in the axial direction of the plurality of eccentric elements between the at least one first translation position and the at least one second translation position.

10. The transfer device according to claim 1, wherein the holding device is configured to receive a plurality of packaging units.

11. The transfer device according to claim 1, wherein the holding device has at least one suction gripper.

12. The transfer device according to claim 1, wherein a distance between the first translation position and the second translation position is 30 to 800 mm.

13. The transfer device according to claim 1, wherein a length of a chord between the retracted position and the operating position is 10 to 200 mm.

14. A method for transferring packaging units from a receiving region to a delivery region by means of a transfer device, wherein the transfer device comprises at least one eccentric unit which comprises:
a rotatably mounted eccentric element, which has a rod lead-through, which is spaced apart from an axis of rotation of the eccentric element in a radial direction and which extends parallel to an axis of rotation of the eccentric element;
a rod, which extends through the eccentric element and which is mounted, by means of the rod lead-through, in a rotatable manner and in a displaceable manner in an axial direction of the eccentric element, wherein the rod lead-through has a radial-axial bearing, which is configured to mount the rod both axially as well as in a rotatory manner with respect to the eccentric element;
a holding device, which is connected to the rod and which is configured to receive at least one packaging unit;
a first drive unit, which is configured to rotate the eccentric element, thereby moving the holding device in a first plane, which is perpendicular to the axis of rotation of the eccentric element, between at least one retracted position and at least one operating position; and
a second drive unit, which is configured to displace the rod between at least one first translation position and at least one second translation position in the axial direction of the eccentric element, thereby moving the holding device parallel to the axis of rotation of the eccentric element;
wherein the method comprises the steps of:
rotating the eccentric element by means of the first drive unit in order to move the holding device into an operating position;
receiving the at least one packaging unit in the receiving region by means of the holding device;
rotating the eccentric element by means of the first drive unit in order to move the holding device into a retracted position;
displacing the rod from a first translation position into a second translation position by means of the second drive unit;
rotating the eccentric element by means of the first drive unit in order to move the holding device into an operating position;
delivering the at least one packaging unit in the delivery region by way of the holding device;
rotating the eccentric element by means of the first drive unit in order to move the holding device into a retracted position; and
displacing the rod from the second translation position into a first translation position by means of the second drive unit.

15. The method for transferring packaging units according to claim 14, wherein the packaging units are continuously moved on a conveying device and the movements of the at least one eccentric unit are synchronized with the movement of the packaging units on the conveying device.
